(19) United States
(12) Patent Application Publication
(10) Pub. No.: US 2007/0058338 A1
(43) Pub. Date: Mar. 15, 2007

(54) CONNECTOR ASSEMBLY AND PORTABLE COMPUTER HAVING THE SAME

(76) Inventor: Hyun-woo LEE, Suwon-si (KR)

Correspondence Address: STANZIONE & KIM, LLP, 919 18TH STREET, N.W., SUITE 440, WASHINGTON, DC, 20006, US

(21) Appl. No.: 11/461,071

(22) Filed: Jul. 31, 2006

(30) Foreign Application Priority Data
Aug. 27, 2005 (KR) 2005-79106

(51) Int. Cl. G06F 1/20

(52) U.S. Cl. 361/687

(57) ABSTRACT

A portable computer includes a display to display an image, a computer body detachably connected with the display, and a connector assembly provided between the display and the computer body to transmit an electrical signal from an antenna provided in the display to the computer body, the connector assembly including a connecting port provided in one of the display and the computer body, a connection jack provided in the other of the display and the computer body and detachably connected with the connecting port, and a guide unit including a guide projection provided in one of the connecting port and the connection jack to guide a connection of the connecting port and the connection jack when the display is connected with the computer body, and a projection receiver provided in the other of the connecting port and the connection jack to receive and guide the guide projection.

### CROSS-REFERENCE TO RELATED APPLICATIONS

This application claims priority under 35 U.S.C. §119(a) from Korean Patent Application No. 2005-0079106, filed on Aug. 27, 2005, in the Korean Intellectual Property Office, the disclosure of which is incorporated herein by reference in its entirety.

### BACKGROUND OF THE INVENTION

1. Field of the Invention

The present general inventive concept relates to a connector assembly used with antenna signals and a portable computer having the same, and more particularly, to a connector assembly with an improved combination structure and a portable computer having the same.

2. Description of the Related Art

In general, a connector assembly includes a connecting port through which antenna signals are transmitted and a connecting jack detachably combined with the connecting port for receiving the antenna signals from the connecting port.

In general, a portable computer includes a computer body, a display for displaying images based on image signals transmitted from the computer body, and a tilting hinge by which the display is tiltably connected to the computer body.

Such a portable computer may include the above-mentioned connector assembly for transmission of the antenna signals. As an example, Japanese Patent Application Publication No. 2004-335157 discloses an antenna device set in a portable computer. The antenna device disclosed in this disclosure includes a transceiver circuit mounted in a computer body, an antenna mounted in a display, a coaxial cable for connecting the transceiver circuit to the antenna, and a receptacle provided in a midway portion of the coaxial cable.

However, even though such a conventional portable computer can connect the antenna to the transceiver circuit using the coaxial cable and the receptacle, if the receptacle is provided in the computer body and the display unit is separated from the computer body, it is difficult to separate (disconnect) the coaxial cable when the display unit is separated from the computer body, and it is also difficult to reconnect the coaxial cable conveniently and safely when the display is connected to the computer body.

### SUMMARY OF THE INVENTION

Accordingly, it is an aspect of the present general inventive concept to provide a connector assembly which is conveniently and safely connectable and separable, and to provide a portable computer having the same.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing a portable computer, comprising a display to display an image and having an antenna, a computer body detachably connectable with the display, a connector assembly provided between the display and the computer body to transmit an electrical signal from the antenna provided in the display to the computer body, the connector assembly comprising a connecting port provided in one of the display and the computer body, a connection jack provided in the other of the display and the computer body and detachably connectable with the connecting port, and a guide unit comprising a guide projection provided in one of the connecting port and the connection jack to guide a connection of the connecting port and the connection jack when the display is connectable with the computer body, and a projection receiver provided in the other of the connecting port and the connection jack to receive and guide the guide projection.

The portable computer may further comprise a combination body rotatably connected with the display, and a combination body support unit provided in the computer body to be connected with and separated from the combination body, wherein the connecting port may be provided in the combination body and the connection jack is provided in the combination body support unit.

The connecting port may comprise a port body, a signal unit provided in the port body, and connected with the antenna to receive the electrical signal, and a ground unit provided in the port body, and the connection jack may comprise a jack body, a signal combination unit provided in the jack body and connected with the signal unit, and a ground combination unit connected with the ground unit.

The antenna may be provided as a pair of antennas in the display, and the signal unit may comprise a main signal unit connected to one of the pair of antennas in the port body and an auxiliary signal unit connected to the other of the pair of antennas in the port body, the auxiliary signal unit being spaced apart from the main signal unit.

At least one guide projection may be provided in the port body and at least one projection receiver is provided in the jack body, and the at least one guide projection may be projected longer than the signal unit and the ground unit from the port body.

The portable computer may further comprise an external port connectable to the connection jack when the display is separated from the computer body, and the external port may comprise an external port body, an external signal unit provided in the external port body and connectable with the signal combination unit, and an external ground unit provided in the external port body and connectable with the ground combination unit.

The external port may further comprise an external antenna set in the external port body, wherein the external signal unit may be provided as in a pair of external signal units and at least one of the pair of external signal units is connected with the external antenna.

The portable computer may further comprise an elastic member provided between the connection jack and the combination body support unit such that the connection jack is elastically and movably connected to the combination body support unit.

The foregoing and/or other aspects and utilities of the present general inventive concept may also be achieved by providing a connector assembly useable with an electrical signal, comprising a connecting port to receive the electrical signal from an antenna, a connection jack detachably connected with the connecting port to receive the electrical signal from the connecting port, and a guide unit comprising a guide projection provided in one of the connecting port and the connection jack, and a projection receiver provided in the other of the connecting port and the connection jack to receive and guide the guide projection when the connecting port is connected to the connection jack.

The connecting port may comprise a port body, a signal unit provided in the port body and connected with the antenna to receive the electrical signal, and a ground unit provided in the port body, and the connection jack may comprise a jack body forming, a signal combination unit provided in the jack body and connected with the signal unit, and a ground combination unit connected with the ground unit.

The signal unit may comprise the signal unit comprises a main signal unit projected from the port body and an auxiliary signal unit projected from the port body, the auxiliary signal unit being spaced apart from the main signal unit, and the signal combination unit may comprise a main signal combination unit and an auxiliary signal combination unit provided in the jack body to receive and connect with the main signal unit and the auxiliary signal unit, respectively.

The ground unit may comprise a projected main ground unit located close to the main signal unit and a projected auxiliary ground unit located close to the auxiliary signal unit, and the ground combination unit may comprise a main ground combination unit and an auxiliary ground combination unit provided in the jack body to receive and connect with the main ground unit and the auxiliary ground unit, respectively

The connecting port may further comprise at least one guide projection provided in the port body and at least one projection receiver provided in the jack body, and the guide projection may be projected longer than the signal unit and the ground unit from the port body.

The main signal unit may comprise a first antenna, the auxiliary signal unit may comprise a second antenna, and the first and second antennas may be different.

The foregoing and/or other aspects and utilities of the present general inventive concept may also be achieved by providing a connecting apparatus useable in a portable computer to connect a display unit thereof with a body portion thereof, the apparatus comprising a first connecting unit to receive an electrical signal, comprising a signal member to receive the electrical signal, a protruding member to protrude a predetermine distance from the first connecting unit, and a second connecting unit, comprising a receiving member corresponding to the signal member to receive the signal member, a guide member to receive the protruding member and to guide the signal member to the receiving member.

The apparatus may further comprise first and second joining members located on the first and second connecting units, respectively, to join together the first and second connecting units. The apparatus may further comprise a securing unit to secure a connection between the first and second connecting units, the securing unit comprising a cover part to cover the connection between the first and second connecting units and having a first locking part, a base part having a second locking part to connect with the first locking part to lock the cover part with the base part, and a release part to release the connection between first and second locking parts.

The guide member may include first and second support rails to support first and second sides of the protruding member when the protruding member is inserted into guide member. The guide member may include an elastic member to absorb a force generated when the protruding member is inserted into the second connecting unit. The first joining member may include a notch and the second joining member has a shape that substantially corresponds to a shape of the notch. The second joining member may include first and second projections positioned on first and second sides of the guide member, and the first joining member may include first and second notches corresponding to the first and second projections.

The signal member may include at least one cable, and the receiving member may include at least one hollow portion to receive the at least one cable therein. The signal member may further include a guide projection, and the receiving member may further include a guide recess to receive the guide projection. The signal member may further include at least one grounding cylinder surrounding the at least one cable, and the receiving member may further include at least one trench surrounding the at least one hollow portion to receiving the at least one grounding cylinder.

The first locking part may include at least one hook. The cover part may be moveable between an unsecured position substantially perpendicular to the base part and a secured position substantially parallel to the base part. The release part may include a pressure sensitive portion to release the connection between the first and second locking parts when pressure is applied to the pressure portion.

The foregoing and/or other aspects and utilities of the present general inventive concept may also be achieved by providing a portable computer, comprising a display unit, a body portion, and at least one connecting apparatus, comprising a first connecting unit to receive and electrical signal, comprising a signal member to receive the electrical signal, a protruding member to protrude a predetermine distance from the first connecting unit, and a second connecting unit, comprising a receiving member corresponding to the signal member to receiving the signal member, a guide member to receive the protruding member and to guide the signal member to the receiving member.

The display unit may include one of the first and second connecting units, and the body portion includes the other of the first and second connecting units. The at least one connecting apparatus may comprise a plurality of connecting apparatuses.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a perspective view illustrating a portable computer, according to an embodiment of the present general inventive concept;

FIG. 2 is a partially exploded perspective view illustrating the portable computer of FIG. 1, according to an embodiment of the present general inventive concept;

FIGS. 3 and 4 are exploded and combined perspective views, respectively, illustrating a combination body of the portable computer of FIGS. 1 and 2 when viewed from a top of the portable computer, according to the embodiment of the present general inventive concept;

FIG. 5 is a combined perspective view illustrating a combination body of the portable computer of FIGS. 1 and 2 when viewed from a bottom of the portable computer, according to the embodiment of the present general inventive concept;

FIGS. 6 and 7 are perspective views illustrating a connector assembly of the portable computer of FIGS. 1 and 2, according to the embodiment of the present general inventive concept; and

FIG. 8 is a perspective view illustrating an additional port of the portable computer of FIGS. 1 and 2, according to the embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

Hereinafter, cases where a connector assembly, according to embodiments of the present general inventive concept, is set in a portable computer, will be illustrated. However, it should be understood that the present general inventive concept is not so limited, and thus connector assemblies according to various embodiments of the present general inventive concept may be set in various electronic apparatuses, such as audio and/or video equipment and the like, which may transmit antenna signals, and thus the present general inventive concept is not restricted to using a connector assembly in a portable computer.

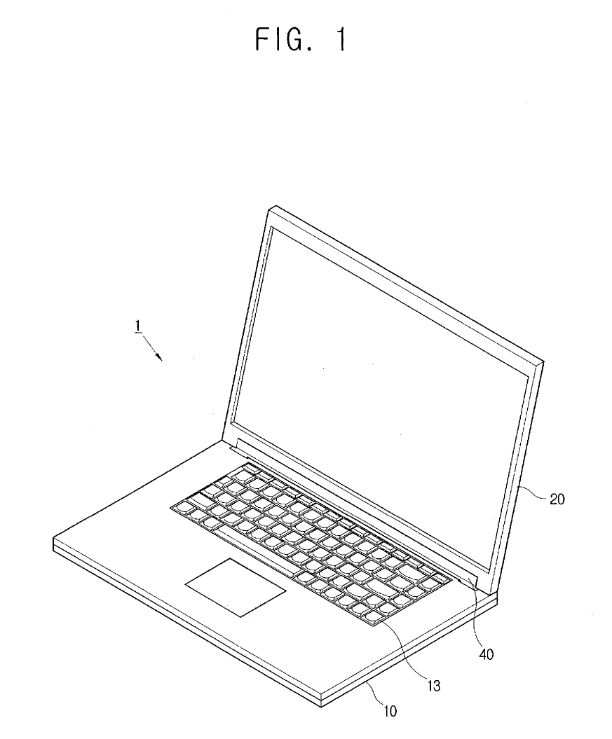

As illustrated in FIGS. 1 to 3, a portable computer 1 of the present general inventive concept includes a display 20 to display an image, a computer body 10 detachably connected with the display 20, and a connector assembly 80 provided respectively in the display 20 and the computer body 10 to connect an antenna signal between the display 20 and the computer body 10. The portable computer 1 further includes a combination body 40 to be rotatably connected with the display 20 and a combination body support unit 50 provided in the computer body 10 to be detachably connected with the combination body 40.

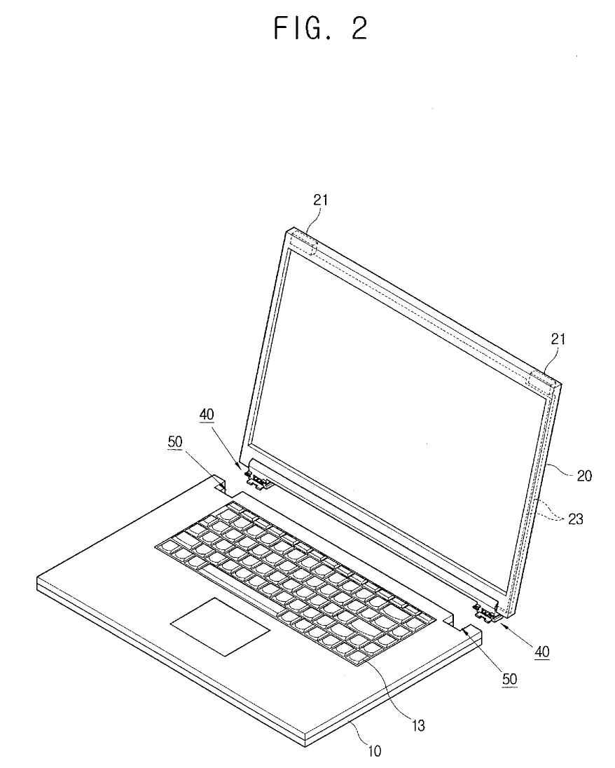

As illustrated in FIGS. 1 and 2, the computer body 10 is safely seated in a horizontal plane, such as a table. The computer body 10 includes components, such as a main board, a CPU, and the like (not illustrated), mounted therein to produce an image signal and the like, and a keyboard 13 for data input by a user.

As illustrated in FIGS. 1 and 2, the display 20 receives the image signal to display an image. A driving circuit (not illustrated) is provided in the display 20 to receive the image signal to display the image. For example, a slim and light LCD panel may be used as the display 20. A pair of antennas 21 can be set in the display 20.

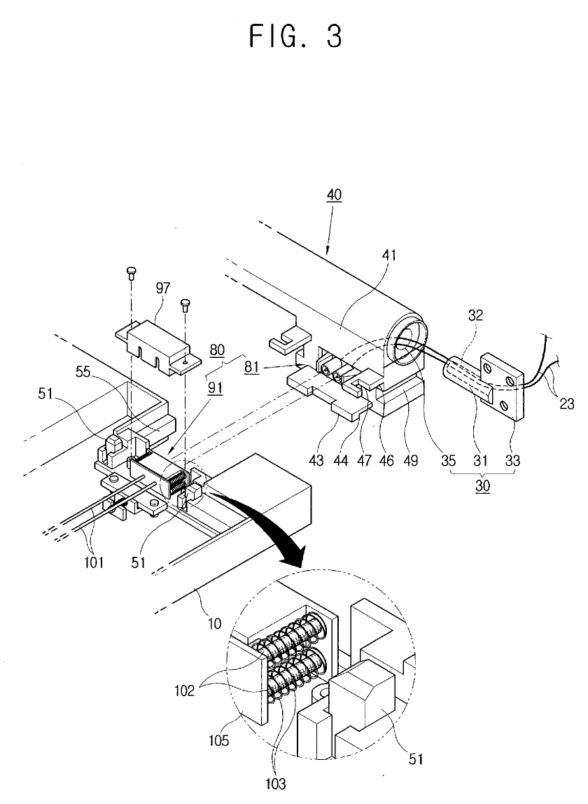

As illustrated in FIG. 3, a hinge unit 30 supports the display 20 and the combination body 40 to allow the display 20 to be tilted around a lengthwise directional axis of the combination body 40. The hinge unit 30 can include a hinge shaft 31 provided between the display 20 and the combination body 40, a shaft support unit 33 provided in one side of the hinge shaft 31 to be connected with the display 20, and a shaft receiving unit 35 provided in the combination body 40, into which the other side of the hinge shaft 31 is inserted.

As illustrated in FIG. 3, a cable through unit 32 is provided in the hinge shaft 31 to receive an antenna cable 23, which will be described later. The shaft support unit 33 may extend to one side of the hinge shaft 31 and may be connected with the display 20 by, for example, a screw or the like, to rotate together with the display 20.

The shaft receiving unit 35 is rotatably connected with the other side of the hinge shaft 31 to provide a rotational friction force thereto.

The antennas 21 (see FIG. 2) are spaced from each other in an upper side of the display 20.

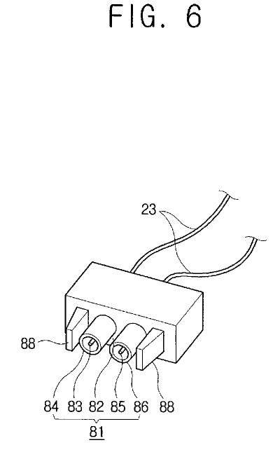

Each antenna 21 is connected to a connecting port 81 of the connector assembly 80, which will be described later, through the antenna cable 23, which may be, for example, a coaxial cable. The antenna cable 23 connects the pair of antennas 21 to a main signal unit 83 (illustrated in FIG. 6) and an auxiliary signal unit 85 (illustrated in FIG. 6) of the connecting port 81, which will be described later, through the cable through unit 32 provided in the hinge shaft 31.

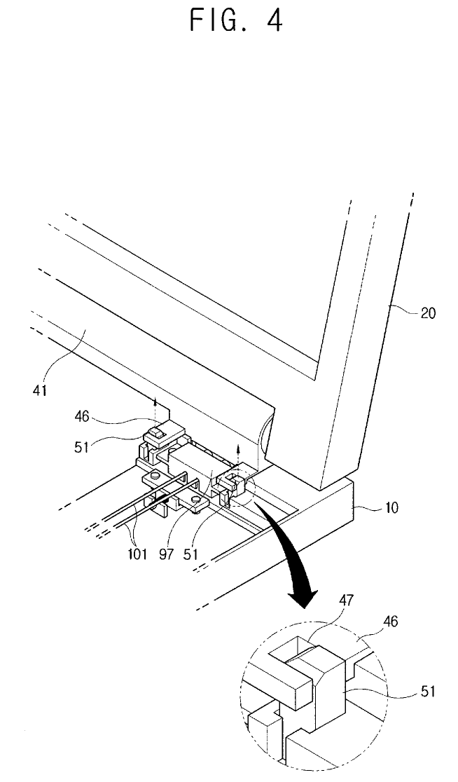

As illustrated in FIGS. 3 and 4, the combination body 40 may include a body unit 41, an insertion member 43 projecting from the body unit 41 in a direction of the combination body support unit 50, and a locking member 46 projecting from the body unit 41 in the direction of the combination body support unit 50 (see FIG. 3). The combination body 40 can be provided with a slide unit 49 to be guided to a guide unit 55 of the combination body support unit 50, which will be described later.

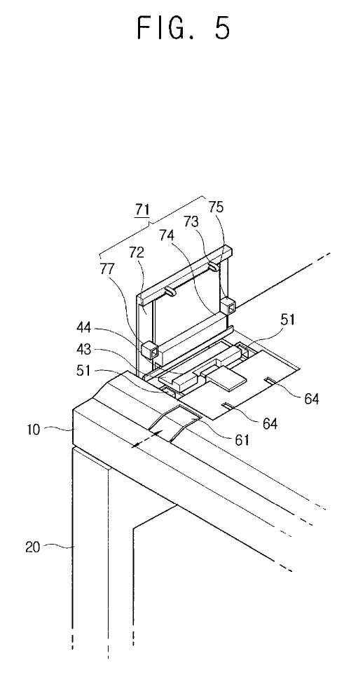

As illustrated in FIGS. 3 and 5, the insertion member 43 can project from the body unit 41 in such a manner that a lengthwise side of the insertion member 43 is combined with the body unit 41. As an example, the insertion member 43 may be provided as a pair of insertion members 43 at opposite sides of the body unit 41. The insertion member 43 may include a fastening jaw 44 provided in a substantially perpendicular direction to an insertion direction of the insertion member 43 with respect to the computer body 10.

The fastening jaw 44 may be engaged to a fastening bar 74 of a joining member 71, which will be described later, in order to prevent the insertion member 43 from separating toward a rear direction in a state where the insertion member 43 is received in the combination body support unit 50. As an example, the fastening jaw 44 may be horizontally formed in a stepped shape at a lower side of the insertion member 43.

As illustrated in FIGS. 3 to 5, the locking member 46 can project from the body unit 41 to be spaced from the insertion member 43. As an example, the locking member 46 may be provided in upper side of the insertion member 43 as a plate parallel to the insertion member 43. The locking member 46 may include a locker 47 provided in a substantially perpendicular direction to an insertion direction of the locking member 46 with respect to the computer body 10.

As illustrated in FIGS. 3 and 4, the locker 47 can be partially cut away in a vertical direction such that a locking projection 51, which will be described later, is moved in the vertical direction to be connected to and released from the locking member 46.

As illustrated in FIG. 3, the slide unit 49 can be provided in opposite sides of one side of the body unit 41 (e.g., on opposite sides of the connecting part 81 of a right side of the body unit 41, as illustrated in FIG. 3) in a manner combinable with the guide unit 55 of the combination body support unit 50, which will be described later.

As illustrated in FIGS. 2 to 5, the combination body support unit 50 may be provided in a rear of the computer body 41 in a manner detachable from the combination body 40. The joining member 71 may be provided at a back side of the combination body support unit 50 to support a lower side of the insertion member 43 and may be connected with the insertion member 43 such that the insertion member 43 is inserted into the combination body support unit 50 and maintained in a supported state (see FIG. 5).

The locking projection 51 may be provided on an upper side of the combination body support unit 50 to support a lower side of the locking member 46, which is movably provided in a substantially perpendicular direction to the insertion direction of the locking member 46 such that the locking member 46 is inserted into the combination body support unit 50 and maintained in a supported state (see FIGS. 4 and 5). The guide unit 55 formed in the insertion direction of the slide unit 49 may be provided in the combination body support unit 50 (see FIG. 3). As an example, the combination body support unit 50 may be provided in a pair at opposite sides of the rear of the computer body 10 corresponding to the body unit 41 (see FIG. 2).

As illustrated in FIGS. 4 and 5, the locking projection 51 is movably provided in a vertical direction with respect to a horizontal surface of the computer body 10 to be connected to the locker 47 of the locking member 46.

The joining member 71 is rotatably provided in a lower side of the computer body 10. The joining member 71 may include a plate-shaped joining body 72, the fastening bar 74 provided in the joining body 72 and engaged to the fastening jaw 44 to prevent the insertion member 43 from separating in a backward direction, locking projection pressurization units 75 and 77 provided in the joining body 72 to pressurize the locking projections 51 such that the locking projections 51 are coupled to the locker 47, and a hook 73 provided in the joining body 72 to be joined with the combination body support unit 50 upon a rotation of the joining member 71.

As illustrated in FIG. 5, the hook 73 may project from the joining body 72 in the form of a ring. A lever 61 may be provided in the combination body support unit 50 to be combined with and released from the hook 73.

As illustrated in FIG. 5, one side of the lever 61 is exposed to the outside of the computer body 10 to allow a user to move the lever 61 without difficulty. A hook projection (not illustrated) can be provided in the other side of the lever 61 to be received in the inside of the computer body 10, can be combined with and released from the hook 73, and can correspond to a hook receiving unit 64 formed in the combination body support unit 50 to receive the hook 73.

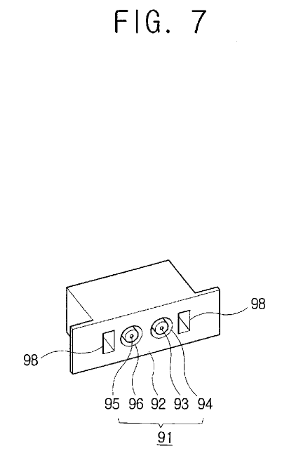

As illustrated in FIGS. 6 and 7, the connector assembly 80 includes a connecting port 81 provided in one of the display 20 and the computer body 10 to have an antenna signal applied thereto, a connection jack 91 provided in the other of the display 20 and the computer body 10 and detachably combined with the connecting port 81 to receive the antenna signal from the connecting port 81, and guide units 88 and 98 provided in the connection port 81 and the connection jack 91 to guide a connection of the coupling port 81 and the connection jack 91 at a time of a connection of the display 20 and the computer body 10.

As illustrated in FIG. 6, the connecting port 81 includes a port body 82, the signal units 83 and 85 provided in the port body 82 to have the antenna signal applied thereto, and ground units 84 and 86 provided in the port body 82. As an example, the connecting port 81 may be provided in one side of the body unit 41 of the combination body 40, or may be provided as a pair at opposite sides of the body unit 41.

The port body 82 is provided in the body unit 41 of the combination body 40 and supports the signal units 83 and 85 and the ground units 84 and 86.

The signal units 83 and 85 include the main signal unit 83 projecting from the port body 82 and the auxiliary signal unit 85 projecting from the port body 82 to be spaced from the main signal unit 83. As an example, the signal units 83 and 85 may be connected to the antennas 21, which are mounted in the display 20, through the antenna cables 23, and may have the antenna signal applied thereto from the antennas 21. However, the signal units 83 and 85 may have various forms of electric signals applied thereto, such as an image signal, voice signal or electric power, and thus are not restricted to the antenna signal. As an example, the signal units 83 and 85 may project from the port body 82 in the form of a pin.

The main signal unit 83 is connected to one of the pair of antennas 21 mounted in the display 20 via the antenna cables 23. The auxiliary signal unit 85 is connected to the other of the pair of antennas 21 mounted in the display 20 via the antenna cables 23. Thus, when the main signal unit 83 and the auxiliary signal unit 85 are respectively connected to a main signal combination unit 93 and an auxiliary signal combination unit 95 of the connection jack 91, a signal receiving unit (not illustrated) built in the computer body 10 can selectively use a better one of an antenna signal transmitted through the main signal unit 83 and an antenna signal transmitted through the auxiliary signal unit 85.

The ground units 84 and 86 include a main ground unit 84 close to the main signal unit 83 to project from the port body 82 and an auxiliary main ground unit 86 close to the auxiliary signal unit 85 to project to from the port body 82. The ground units 84 and 86 may be provided in the form of a cylinder to surround the outside of the signal units 83 and 85.

As illustrated in FIG. 7, the connection jack 91 includes a jack body 92, the signal combination units 93 and 95 provided in the jack body 92 to be combined with the signal units 83 and 85, and ground combination units 94 and 96 to be combined with the ground units 85 and 86. As an example, the connection jack 91 may be provided as one of a pair of combination body support units 50 corresponding to the connecting port 81, or may be provided as both of the pair of combination body support units 50. An elastic member 103 (see FIG. 3) may be provided between the connection jack 91 and the combination body support unit 50 to allow the connection jack 91 to be elastically combined to the combination body support unit 50.

The jack body 91 is provided in the combination body support unit 50 to support the signal combination units 93 and 95 and the ground combination units 94 and 96. The jack body 91 may be covered by a jack body cover 97, which may be connected to the jack body 91 by, for example, a screw or the like.

The signal combination units 93 and 95 include the main signal combination unit 93 and the auxiliary signal combination unit 95, which are provided in the jack body 91, to receive and combine the main signal unit 83 and the auxiliary signal unit 85. The signal combination units 93 and 95 are connected to a signal receiving unit (not illustrated), which is built in the computer body 10, via an internal cable 101. Thus, the signal combination units 93 and 95 can transmit an antenna signal received from the antenna 21 to the signal receiving unit (not illustrated) built in the computer body 10 when the signal units 83 and 85 are combined to the signal combination units 93 and 95. The signal combination units 93 and 95 may be provided in the form of a hole to receive and connect the pin-shaped signal units 83 and 85, which may contact each other when connected.

The ground combination units 94 and 96 include a main ground combination unit 94 and an auxiliary ground combination unit 96, which are provided in the jack body 91, to receive and connect the main ground unit 84 and the auxiliary ground unit 86. The ground combination units 94 and 96 are depressedly formed in a circular section to receive and connect the cylindrical ground units 84 and 86, which may contact each other when connected. The ground combination units 94 and 96 may be connected to a ground cable (not illustrated) or a ground circuit (not illustrated) or the like, which is built in the computer body 10, to ground the ground units 84 and 86 of the connecting port 81.

Referring to FIG. 3, the elastic member 103 is provided between an elastic member support unit 105, which is integrally attached to the combination body support unit 50, and the jack body 91, and thus can absorb a connecting shock since the jack body 92 of the connection jack 91 can move elastically in the direction of the elastic member support unit 105 when the connecting port 81 is connected to the connection jack 91. The elastic member 103 may be provided in the form of, for example, a coil spring to be inserted into an elastic member support screw 102 provided between the elastic member support unit 105 and the jack body 91. Thus, the elastic member 103 can absorb an impact generated when the connecting port 81 is connected to the connection jack 91 and can also prevent damage by elastically moving the connection jack 91 when the combination body 40 moves with respect to the combination body support unit 50.

Referring to FIGS. 6 and 7, the guide units 88 and 98 include a guide projection 88 provided in one of the connecting port 81 and the connection jack 91 (illustrated as part of the connecting port 81 in FIG. 6), and a projection receiver 98 provided in the other of the connecting port 81 and the connection jack 91 (illustrated as part of the connection jack 91 in FIG. 7) to receive and guide the guide projection 88 when the connecting port 81 is connected to the connection jack 91.

As an example, the guide projection 88 may be forwardly projected from the port body 82. However, the guide projection 88 may instead be projected from the jack body 91. As an example, the guide projection 88 is provided as a pair of guide projections 88 in both sides of the signal units 83 and 85 and the ground units 84 and 86. The guide projection 88 may be projected longer than the signal units 83 and 85 and the ground units 84 and 86 from the port body 82. Thus, when the combination body 40 is connected to the combination body support unit 50, the guide projection 88 is inserted into the projection receiver 98, which is provided in the connection jack 91, earlier than the signal units 83 and 85 and the ground units 84 and 86. Accordingly, the signal units 83 and 85 and the ground units 84 and 86 may conveniently and safely be connected to the signal combination units 93 and 95 and the ground combination units 94 and 96.

As an example, the projection receiver 98 may be depressedly formed in the jack body 91 to receive and combine with the guide projection 88. However, the projection receiver 98 may instead be provided in the port body 82 if the guide projection 88 is provided in the jack body 91. As an example, the projection receiver 98 may be provided as a pair of projection receivers 98 in both sides of the signal combination units 93 and 95 and the ground combination units 94 and 96.

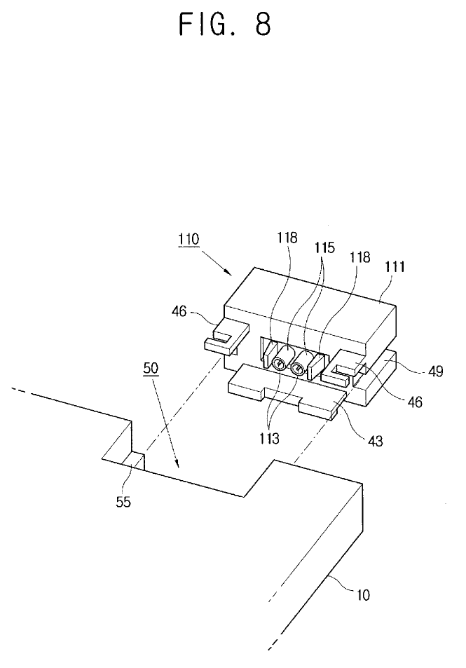

As illustrated in FIG. 8, the portable computer 1 of the present general inventive concept may further include an external port 110 connected to the connection jack 91 under a condition where the display 20 is separated from the computer body.

The external port 110 includes an external port body 111, an external antenna (not illustrated) set in the external port body 111, an external signal unit 113 provided in the external port body 111 and connected to the external antenna (not illustrated), and an external ground unit 115 provided in the external port body 111. Thus, the external port 110 may function as a portable antenna to be connected to the connection jack 91 provided in the computer body 10 as desired. An external guide projection 118 is provided in the external port 110 to guide the external port 110 to the projection receiver 98.

In the external port body 111, the external signal unit 113, the external ground unit 115, and the external guide projection are projected and supported. The locking member 46, the insertion member 43, and the slide unit 49, as described above, may be provided in the external port body 111 to be connectable to the combination body support unit 50 of the computer body 10.

As an example, the external signal unit 113 may be connectable to the signal combination units 93 and 95 of the connection jack 91. Also, the external signal unit 113 may be provided as a pair of external signal units 113 such that more than one of the pair of external signal units 113 is connected to the external antenna (not illustrated). However, a single external signal unit 113 may be provided to be connected to the external antenna (not illustrated) by a cable (not illustrated). The external signal unit 113 may provided similarly to the above-described signal units 83 and 85, and therefore, a detailed explanation thereof will be omitted.

As an example, the external ground unit 115 may be connectable to the ground combination units 94 and 96 of the connection jack 91. Also, the external ground unit 115 may be provided as a pair of external ground units 115 such that both of the external ground units 115 are connected to the ground cable (not illustrated) and the like. However, a single external ground unit 115 may be provided to be connected to the ground cable (not illustrated) and the like. The external ground unit 115 is provided similarly to the above-described ground units 85 and 86, and therefore, a detailed explanation thereof will be omitted.

The external guide projection 118 may be provided similarly to the above-described guide projection, and therefore, a detailed explanation thereof will be omitted.

With the configuration of the portable computer 1 as described above, operation of the portable computer 1 will be now described.

Under a condition where the combination body 40 is separated from the combination body support unit 50 as illustrated in FIGS. 3 to 5, an operation of combining the combination body 40 with the combination body support unit 50 will be described. The insertion member 43 and the locking member 46 provided in the body unit 41 of the combination body 40 are inserted into the combination body support unit 50 (see FIG. 4). At this time, the slide unit 49 of the body unit 41 is guided along the guide unit 55 to facilitate the insertion of the insertion member 43 and the locking member 46. Then, the joining member 71 is rotated to allow the hook 73 to be engaged to the lever 61 (see FIG. 5). Then, the fastening bar 74 is fastened to the fastening jaw 44 of the insertion member 43, and the locking projection 51 is connected to the locker 47 (see FIG. 4). Then, the connection port 81 provided in the body unit 41 is connected to the connection jack 91 provided in the combination body support unit 50. At this time, the connecting port 81 is guided by the guide units 88 and 98 to be conveniently and safely connected to the connection jack 91. In other words, the signal units 83 and 85 and the ground units 84 and 86 of the connecting port 81 are guided by the guide projection 88 and the projection receiver 98 to be conveniently and safely connected to the signal combination units 93 and 95 and the ground combination units 94 and 96. Thus, the combination body 40 is connected to the combination body support unit 50. Accordingly, a user can connect the display 20 to the computer body 10 without difficulty by rotating the joining member 71 such that the hook 73 is fastened to the lever 61 after inserting the combination body 40 into the combination body support unit 50.

An operation of separating the combination body 40 from the combination body support unit 50 will be now described. First, the hook projection (not illustrated) of the lever 61 is separated from the hook 73 to rotate the joining member 71. Then, the fastening bar 74 and the locking projection 51 are separated from the fastening jaw 44 and the locker 47. Thereafter, the insertion member 43 and the locking member 46 are separated from the combination body support unit 50 (see FIG. 3). Then, the connecting port 81 provided in the body unit 41 is separated from the connection jack 91 provided in the combination body support unit 50. At this time, the connecting port 81 is guided by the guide units 88 and 98 to be conveniently and safely separated from the connection jack 91. In other words, the signal units 83 and 85 and the ground units 84 and 86 of the connecting port 81 are guided by the guide projection 88 and the projection receiver 98 to be conveniently and safely separated to the signal combination units 93 and 95 and the ground combination units 94 and 96. Accordingly, a user can separate the display 20 from the computer body 10 without difficulty by separating the combination body 40 from the combination body support unit 50 by manipulating the lever 61.

In addition, when the connecting port 81 is separated from the connection jack 91, the external port 110 may be connected to the connection jack 91 provided in the computer body 10, as desired, to function as a portable antenna. In addition, a separate connection jack (not illustrated) may be provided in the computer body 10 to be connectable with the external port 110, even under a condition where the computer body 10 is connected with the display 20.

In addition, a connecting force between the display 20 and the computer body 10 can be increased by connecting the display 20 to the combination body support unit 50 provided in the computer body 10 using a plurality of connecting members, such as the insertion member 43 and the locking member 46 provided in the combination body 40.

Furthermore, damage of the connecting port 81 and the connection jack 91 can be prevented by the elastic member 103 mounted in the connection jack 91.

As apparent from the description, the present general inventive concept provides a connector assembly which is conveniently and safely connectable and separable, and a portable computer having the same.

In addition, the present general inventive concept provides a portable computer in which an external port mounted with an additional antenna can be conveniently and safely connected to and separated from a connection jack.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A portable computer, comprising:
a display to display an image and having an antenna;
a computer body detachably connectable with the display; and
a connector assembly provided between the display and the computer body to transmit an electrical signal from the antenna provided in the display to the computer body, the connector assembly comprising:
a connecting port provided in one of the display and the computer body;
a connection jack provided in the other of the display and the computer body and detachably connectable with the connecting port; and
a guide unit comprising a guide projection provided in one of the connecting port and the connection jack to guide a connection of the connecting port and the connection jack when the display is connectable with the computer body, and a projection receiver provided in the other of the connecting port and the connection jack to receive and guide the guide projection.

2. The portable computer according to claim 1, further comprising:
a combination body rotatably connected with the display; and
a combination body support unit provided in the computer body to be connected with and separated from the combination body,
wherein the connecting port is provided in the combination body and the connection jack is provided in the combination body support unit.

3. The portable computer according to claim 2, wherein:
the connecting port comprises a port body, a signal unit provided in the port body, and connected with the antenna to receive the electrical signal, and a ground unit provided in the port body; and
the connection jack comprises a jack body, a signal combination unit provided in the jack body and connected with the signal unit, and a ground combination unit connected with the ground unit.

4. The portable computer according to claim 3, wherein the antenna is provided as a pair of antennas in the display, and the signal unit comprises a main signal unit connected to one of the pair of antennas in the port body and an auxiliary signal unit connected to the other of the pair of antennas in the port body, the auxiliary signal unit being spaced apart from the main signal unit.

5. The portable computer according to claim 4, wherein at least one guide projection is provided in the port body and at least one projection receiver is provided in the jack body, and the at least one guide projection is projected longer than the signal unit and the ground unit from the port body.

6. The portable computer according to claim 3, further comprising:
an external port connectable to the connection jack when the display is separated from the computer body, the external port comprising an external port body, an external signal unit provided in the external port body and connectable with the signal combination unit, and an external ground unit provided in the external port body and connectable with the ground combination unit.

7. The portable computer according to claim 6, wherein the external port further comprises:
an external antenna set in the external port body,
wherein the external signal unit is provided as a pair of external signal units and at least one of the pair of external signal units is connected with the external antenna.

8. The portable computer according to claim 2, further comprising:
an elastic member provided between the connection jack and the combination body support unit such that the connection jack is elastically and movably connected to the combination body support unit.

9. A connector assembly useable with an electrical signal, comprising:
a connecting port to receive the electrical signal from an antenna;
a connection jack detachably connected with the connecting port to receive the electrical signal from the connecting port; and
a guide unit comprising a guide projection provided in one of the connecting port and the connection jack, and a projection receiver provided in the other of the connecting port and the connection jack to receive and guide the guide projection when the connecting port is connected to the connection jack.

10. The connector assembly according to claim 9, wherein:
the connecting port comprises a port body, a signal unit provided in the port body and connected with the antenna to receive the electrical signal, and a ground unit provided in the port body; and
the connection jack comprises a jack body forming, a signal combination unit provided in the jack body and connected with the signal unit, and a ground combination unit connected with the ground unit.

11. The connector assembly according to claim 10, wherein:
the signal unit comprises a main signal unit projected from the port body and an auxiliary signal unit projected from the port body, the auxiliary signal unit being spaced apart from the main signal unit;, and
the signal combination unit comprises a main signal combination unit and an auxiliary signal combination unit provided in the jack body to receive and connect with the main signal unit and the auxiliary signal unit, respectively.

12. The connector assembly according to claim 11, wherein:
the ground unit comprises a projected main ground unit located close to the main signal unit and a projected auxiliary ground unit located close to the auxiliary signal unit; and
the ground combination unit comprises a main ground combination unit and an auxiliary ground combination unit provided in the jack body to receive and connect with the main ground unit and the auxiliary ground unit, respectively.

13. The connector assembly according to claim 12, wherein:
the connecting port further comprises at least one guide projection provided in the port body and at least one projection receiver provided in the jack body; and
the guide projection is projected longer than the signal unit and the ground unit from the port body.

14. The connector assembly according to claim 11, wherein the main signal unit comprises a first antenna, the auxiliary signal unit comprises a second antenna, and the first and second antennas are different.

15. A connecting apparatus useable in a portable computer to connect a display unit thereof with a body portion thereof, the apparatus comprising:
a first connecting unit to receive an electrical signal, comprising:
a signal member to receive the electrical signal, and
a protruding member to protrude a predetermine distance from the first connecting unit; and
a second connecting unit, comprising:
a receiving member corresponding to the signal member to receive the signal member, and
a guide member to receive the protruding member and to guide the signal member to the receiving member.

16. The apparatus of claim 15, further comprising:
first and second joining members located on the first and second connecting units, respectively, to join together the first and second connecting units.

17. The apparatus of claim 16, further comprising:
a securing unit to secure a connection between the first and second connecting units, the securing unit comprising:
a cover part to cover the connection between the first and second connecting units and having a first locking part,
a base part having a second locking part to connect with the first locking part to lock the cover part with the base part, and
a release part to release the connection between first and second locking parts.

18. The apparatus of claim 15, wherein the guide member includes first and second support rails to support first and second sides of the protruding member when the protruding member is inserted into guide member.

19. The apparatus of claim 15, wherein the guide member includes an elastic member to absorb a force generated when the protruding member is inserted into the second connecting unit.

20. The apparatus of claim 16, wherein the first joining member includes a notch and the second joining member has a shape that substantially corresponds to a shape of the notch.

21. The apparatus of claim 16, wherein the second joining member includes first and second projections positioned on first and second sides of the guide member, and the first joining member includes first and second notches corresponding to the first and second projections.

22. The apparatus of claim 15, wherein the signal member includes at least one cable, and the receiving member includes at least one hollow portion to receive the at least one cable therein.

23. The apparatus of claim 17, wherein the first locking part includes at least one hook.

24. The apparatus of claim 17, wherein the cover part is moveable between an unsecured position substantially perpendicular to the base part and a secured position substantially parallel to the base part.

25. The apparatus of claim 17, wherein the release part includes a pressure sensitive portion to release the connection between the first and second locking parts when pressure is applied to the pressure portion.

26. A portable computer, comprising:
a display unit;
a body portion; and
at least one connecting apparatus, comprising:
a first connecting unit to receive and electrical signal, comprising:
a signal member to receive the electrical signal, and
a protruding member to protrude a predetermine distance from the first connecting unit; and
a second connecting unit, comprising:
a receiving member corresponding to the signal member to receiving the signal member, and
a guide member to receive the protruding member and to guide the signal member to the receiving member.

27. The portable computer of claim 26, wherein the display unit includes one of the first and second connecting units, and the body portion includes the other of the first and second connecting units.
